(19) United States
(12) Patent Application Publication
(10) Pub. No.: US 2023/0385312 A1
(43) Pub. Date: Nov. 30, 2023

(54) COMPUTER-READABLE RECORDING MEDIUM HAVING STORED THEREIN REGISTERING PROGRAM, METHOD FOR REGISTERING, AND INFORMATION PROCESSING APPARATUS

(71) Applicant: Fujitsu Limited, Kawasaki-shi (JP)

(72) Inventor: Naoki TAKAHASHI, Kawasaki (JP)

(73) Assignee: Fujitsu Limited, Kawasaki-shi (JP)

(21) Appl. No.: 18/176,691

(22) Filed: Mar. 1, 2023

(30) Foreign Application Priority Data
May 27, 2022 (JP) 2022-086673

(51) Int. Cl. G06F 16/332

(52) U.S. Cl. CPC G06F 16/3329; G06F 16/3326

(57) ABSTRACT

A non-transitory computer-readable recording medium has stored therein a registering program that causes one or more computers to execute a process including inputting a search question and a sentence contained in a result of a search related to the search question into a machine learning model and obtaining a question sentence based on the search question and the sentence contained in the result of the search from the machine learning model; and registering a combination of the question sentence and the sentence contained in the result of the search, serving as a combination of a question and an answer, into a storing device.

### CROSS-REFERENCE TO RELATED APPLICATION

This application is based upon and claims the benefit of priority of the prior Japanese Patent application No. 2022-086673, filed on May 27, 2022, the entire contents of which are incorporated herein by reference.

### FIELD

The embodiment discussed herein is directed to a computer-readable recording medium having stored therein a registering program, a method for registering, and an information processing apparatus.

### BACKGROUND

Some support centers or websites use information formed by accumulating combinations of questions and answers, such as FAQ (Frequency Asked Question), for knowledge-sharing with users or operators.

In generation of an FAQ, a large number of processes and costs such as labor costs may be incurred due to the intervention of man-hour for extracting and elaborating sentences.

In order to reduce the costs for generating an FAQ, for example, a method is known in which a computer infers question sentences with a machine learning model on the basis of answer sentences obtained from files such as manuals.

For example, related arts are disclosed in International Publication Pamphlet No. WO2020/170912, Japanese Laid-open Patent Publication No. 2006-119991, Japanese Laid-open Patent Publication No. 2020-71690, and Japanese Laid-open Patent Publication No. 2013-50896.

### SUMMARY

According to an aspect of the embodiments, a non-transitory computer-readable recording medium has stored therein a registering program that causes one or more computers to execute a process including inputting a search question and a sentence contained in a result of a search related to the search question into a machine learning model and obtaining a question sentence based on the search question and the sentence contained in the result of the search from the machine learning model; and registering a combination of the question sentence and the sentence contained in the result of the search, serving as a combination of a question and an answer, into a storing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an FAQ generating system according to an embodiment;

FIG. 2 is a block diagram illustrating an example of a hardware (HW) configuration of a computer that achieves the function of a FAQ generating device according to the one embodiment;

FIG. 3 is a block diagram illustrating an example of a software configuration of the FAQ generating system according to the one embodiment;

FIG. 4 is a diagram illustrating an example of a search list screen displayed on a display device of a terminal;

FIG. 5 is a diagram illustrating an example of a search result screen displayed on a display device of a terminal;

FIG. 6 is a diagram illustrating an example of a QA pair registration confirming screen displayed on a display device of a terminal; and

FIG. 7 is a flow diagram illustrating an example of operation of the FAQ generating system of the one embodiment.

### DESCRIPTION OF EMBODIMENT(S)

If question sentences are inferred from answer sentences with a machine learning model, there is a possibility that the answer sentences do not contain sufficient information to worsen the accuracy of the inferred question sentences than those generated by man. Such poor accuracy of inferred question sentences may mean that appropriate (useful) combinations of questions and answers for users or operators are not obtained.

As the above, if question sentences are inferred from answer sentences with a machine learning model, the quality of combinations of questions and answers in the generation of the combination may worsen than those generated by man.

Hereinafter, the embodiment of the present disclosure will now be described with reference to the drawings. However, the embodiment described below are merely illustrative and there is no intention to exclude the application of various modifications and techniques that are not explicitly described in the embodiment. For example, the present embodiment can be variously modified and implemented without departing from the scope thereof. In the drawings used in the following description, the same reference numbers denote the same or similar parts unless otherwise specified.

### (A) Example of Configuration of FAQ Generating System According to One Embodiment

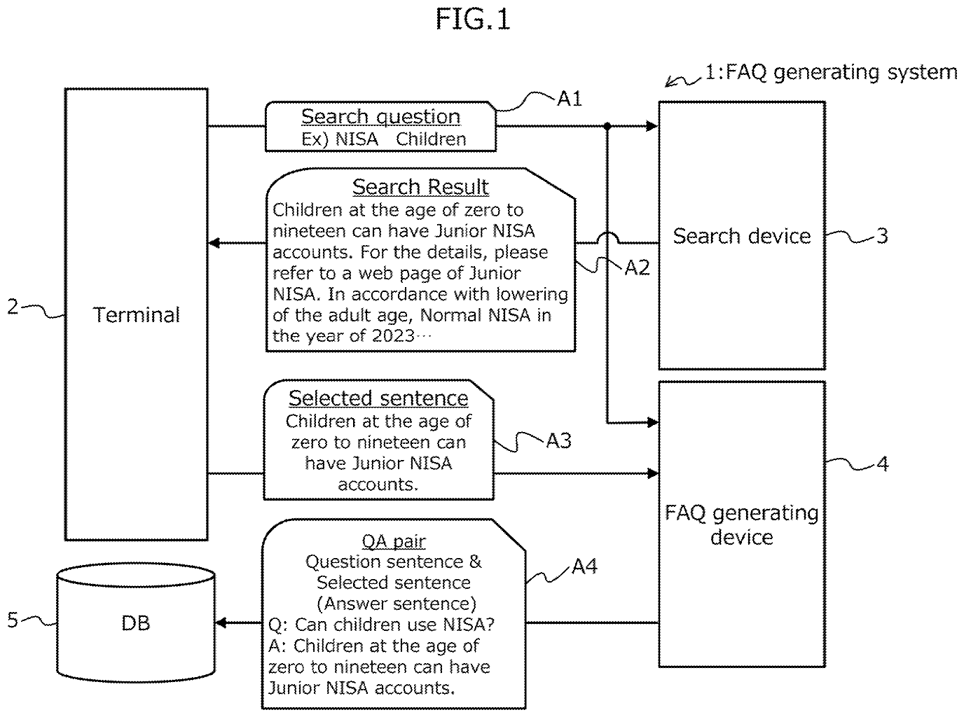

FIG. 1 is a block diagram illustrating an example of a configuration of an FAQ generating system 1 according to the one embodiment. Hereinafter, an FAQ generating system 1 will be exemplified as a method of generating combinations of questions and answers according to the one embodiment.

The FAQ generating system 1 is, for example, a system that assists an operator of a support center in the maintenance of a FAQ, for example, generation and registration of the FAQ. For example, an operator may have doubts (uncertain points) in the support service at the support center and may search (collect) information to resolve the doubts. In addition, the operator shall maintain the FAQ used by the support center, retrieving the information for the solution of the doubts.

As illustrated in FIG. 1, the FAQ generating system 1 may exemplarily include a terminal 2, a search device 3, an FAQ generating device 4, and a DB (Database) 5.

The terminal 2, the search device 3, the FAQ generating device 4, and the DB 5 may be communicably connected to one another via a non-illustrated network. The network may include, for example, one or both of the Internet and a LAN (Local Area Network).

The terminal 2 is, for example, a computer used by an operator of the support center. Examples of the terminal 2 include a PC (Personal Computer), a smart phone, and a tablet computer.

An example of the search device 3 includes a computer or a system provided with a search engine. For example, the search device 3 searches for information related to a search question received from the terminal 2 by means of the search engine and transmits the result of the search to the terminal 2. The search engine searches, for example, multiple web sites in a network such as the Internet for a content (e.g., a letter string or a file) of a Web site highly correlated with the search question, but is not limited to this. Alternatively, the search engine may be an application that searches multiple predetermined files of documents and texts for the content highly correlated with a search question.

The FAQ generating device 4 is a computer such as a server or a PC that generates an FAQ. For example, the FAQ generating device 4 generates a QA (Question Answer or Question Answering) pair based on information received from the terminal 2 and registers it into the DB 5.

The DB 5 is an example of a storage device, and is a computer or a storage device that stores multiple QA pairs as an FAQ.

### (B) Example of Hardware Configuration

The FAQ generating device 4 according to the one embodiment may be a virtual server (Virtual Machine: VM) or a physical server. The function of the FAQ generating device 4 may be achieved by a single computer or by two or more computers. Furthermore, at least part of the function of the FAQ generating device 4 may be achieved by resource of hardware (HW) and/or resource of a network (NW) resource provided by a cloud environment.

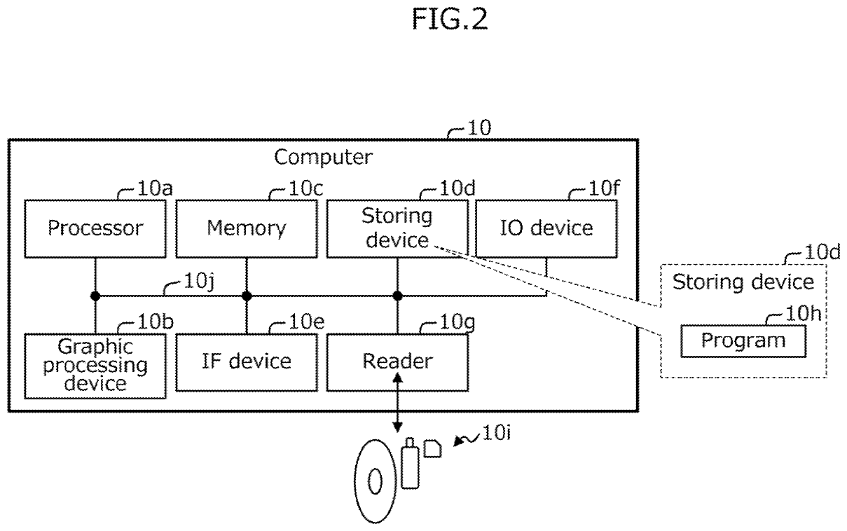

FIG. 2 is a block diagram illustrating an example of a hardware (HW) configuration of a computer 10 that achieves the function of the FAQ generating device 4 according to the one embodiment. If multiple computers are used as the HW resources for achieving the functions of the FAQ generating device 4, each of the computers may include the HW configuration illustrated in FIG. 2.

As illustrated in FIG. 2, the computer 10 may illustratively include a HW configuration formed of a processor 10a, a graphic processing device 10b, a memory a storing device 10d, an I/F (Interface) device 10e, an IO (Input/Output) device 10f, and a reader 10g.

The processor 10a is an example of an arithmetic operation processing device that performs various controls and calculations. The processor 10a may be communicably connected to the blocks in the computer 10 via a bus 10j. The processor 10a may be a multiprocessor including multiple processors, may be a multicore processor having multiple processor cores, or may have a configuration having multiple multicore processors.

The processor 10a may be any one of integrated circuits (ICs) such as Central Processing Units (CPUs), Micro Processing Units (MPUs), Accelerated Processing Units (APUs), Digital Signal Processors (DSPs), Application Specific ICs (ASICs) and Field Programmable Gate Arrays (FPGAs), or combinations of two or more of these ICs.

The graphic processing device 10b executes a screen displaying control on an outputting device such as a monitor included in IO device 10f. The graphic processing device may have a configuration as an accelerator that executes a machine learning process and an inference process using a machine learning model. Example of the graphic processing device 10b are various type of arithmetic operation processing apparatus, and include ICs such as GPUs, APUs, DSPs, ASICs, and FPGAs.

The memory 10c is an example of a HW device that stores information such as various types of data and programs. Examples of the memory 10c include one or both of a volatile memory such as a Dynamic Random Access Memory (DRAM) and a non-volatile memory such as a Persistent Memory (PM).

The storing device 10d is an example of a HW device that stores information such as various types of data and programs. Examples of the storing device 10d include a magnetic disk device such as a Hard Disk Drive (HDD), a semiconductor drive device such as a Solid State Drive (SSD), and various storing devices such as a non-volatile memory. Examples of the non-volatile memory include a flash memory, a Storage Class Memory (SCM), and a Read Only Memory (ROM).

The storing device 10d may store a program 10h (registering program) that implements all or part of various functions of the computer 10.

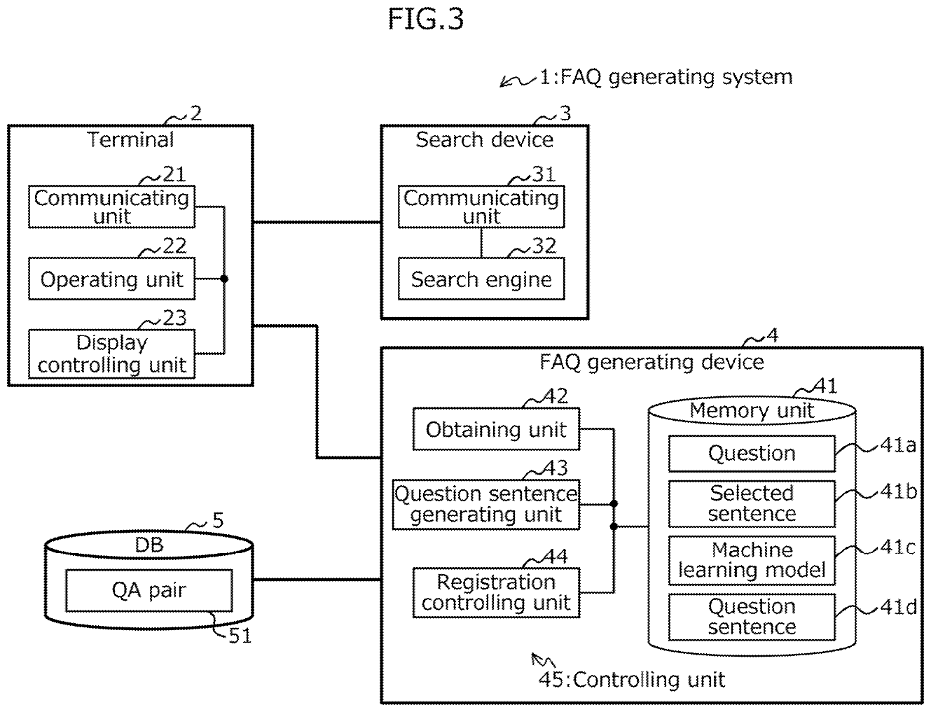

For example, the processor 10a of the FAQ generating device 4 can achieve the functions of the FAQ generating device 4 (for example, a controlling unit 45 illustrated in FIG. 3) to be detailed below by expanding the program 10h stored in the storing device 10d onto the memory and executing the expanded program 10h.

The I/F device 10e is an example of a communication IF that controls connection and communication between the FAQ generating device 4 and another computer. For example, the I/F device 10e may include an applying adapter conforming to Local Area Network (LAN) such as Ethernet (registered trademark) or optical communication such as Fibre Channel (FC). The applying adapter may be compatible with one of or both wireless and wired communication schemes.

For example, the FAQ generating device 4 may be communicably connected, through the IF device 10e and a non-illustrated network, to each of the terminal 2, the search device 3, and the DB 5 illustrated in FIG. 1. Furthermore, the program 10h may be downloaded from the network to the computer 10 through the communication IF and be stored in the storing device 10d, for example.

The IO device 10f may include one or both of an input device and an output device. Examples of the input device include a keyboard, a mouse, and a touch panel. Examples of the output device include a monitor, a projector, and a printer. The IO device 10f may include, for example, a touch panel that integrates an input device and an output device. The output device may be connected to the graphic processing device 10b.

The reader 10g is an example of a reader that reads data and programs recorded on a recording medium 10i. The reader 10g may include a connecting terminal or device to which the recording medium 10i can be connected or inserted. Examples of the reader 10g include an applying adapter conforming to, for example, Universal Serial Bus (USB), a drive apparatus that accesses a recording disk, and a card reader that accesses a flash memory such as an SD card. The program 10h may be stored in the recording medium 10i. The reader 10g may read the program 10h from the recording medium 10i and store the read program 10h into the storing device 10d.

The recording medium 10i is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus.

The computers that achieve the respective functions of the terminal 2, the search device 3, and the DB 5 may have the same HW configuration as that of the computer 10 illustrated in FIG. 2.

### (C) Example of Software Configuration

FIG. 3 is a block diagram illustrating an example of a software configuration of the FAQ generating system 1 according to the one embodiment. Hereinafter, description will now be made in relation to an example of the software configuration of the FAQ generating system 1 with reference to FIGS. 1 and 3.

As illustrated in FIG. 3, the terminal 2 may illustratively include a communicating unit 21, an operating unit 22, and a display controlling unit 23. These software configurations may be achieved by, for example, hardware of the computer 10 (see FIG. 2) serving as the terminal 2.

The communicating unit 21 performs various communications with the search device 3 and the FAQ generating device 4. For example, the communicating unit 21 may transmit letter strings such as a search question (question 41a) and a selected text (selected sentence 41b), information related to various selections, and receive information related to candidates for the result of a search or the result of a search, and information related to displaying of various screens.

The operating unit 22 receives an operation input made by an operator via an input device (e.g., the IO device 10f in FIG. 2), and outputs operation information corresponding to the operation input to the communicating unit 21 or the display controlling unit 23. For example, the operation input may include, for example, input of a text such as a search question, selection of candidates for the result of a search or the result of a search related to a search question, selection of a text, and input or selection of various types of information.

The display controlling unit 23 controls various displaying on a displaying device (for example, IO device 10f in FIG. 2) of the terminal 2. The display controller 23 may display various screens on the displaying device in accordance with the information that communicating unit 21 receives and the operation information inputted via the operating unit 22.

The search device 3 may illustratively include a communicating unit 31 and a search engine 32. These software configurations may be achieved by, for example, hardware of the computer 10 (see FIG. 2) serving as the search device 3.

The communicating unit 31 performs various communications with the terminal 2. For example, the communicating unit 31 may transmit information related to candidates for the result of a search or the result of a search and information related to displaying of various screens, and receive information of a text such as a search question and various selections.

The search engine 32 outputs a content related to an inputted question, which content is exemplified by information of a web site or a web page. The search engine 32 may include, for example, a storing region such as a DB that stores information used for a search, and a processing function that searches for a content that is highly compatible with a question from the storing region. Examples of the information used for a search include a content itself or an index of the content.

For example, in the reference sign A1 of FIG. 1, the communicating unit 21 of the terminal 2 transmits a question 41a inputted by the operator via the operating unit 22 for solving a doubt to both of the search device 3 and the FAQ generating device 4. In the example of FIG. 1, a question 41a is ““NISA (Nippon Individual Savings Account)” “Children””.

In the reference sign A2 of FIG. 1, the search device 3 inputs the question 41a ““NISA” “Children”” that the communicating unit 31 received into the search engine 32, obtains the result of the search from the search engine 32, and transmits the result of the search from the communicating unit 31 to the terminal 2. In the example of FIG. 1, the result of the search is that “Children at the age of zero to nineteen can have Junior NISA accounts. For the details, please refer to a web page of Junior NISA. In accordance with lowering of the adult age, Normal NISA in the year of 2023 . . . ”

The “optimal solution” may be, for example, a content that the search engine 32 evaluates to be optimal for the letter string of the question 41a.

For example, in the reference sign A2 of FIG. 1, the search device 3 may obtain a list of candidates for the result of a search from the search engine 32 inputted with the question 41a, and transmit the list to the terminal 2. In this case, if receiving information indicating (selecting) any of the candidates for the result of the search in the list from the terminal 2, the search device 3 may transmit the content of the indicated candidate of the result of the search, as the result of the search, to the terminal 2. In this case, the “optimal solution” can be regarded as a content that the operator determines to be optimal for the solution to the doubt.

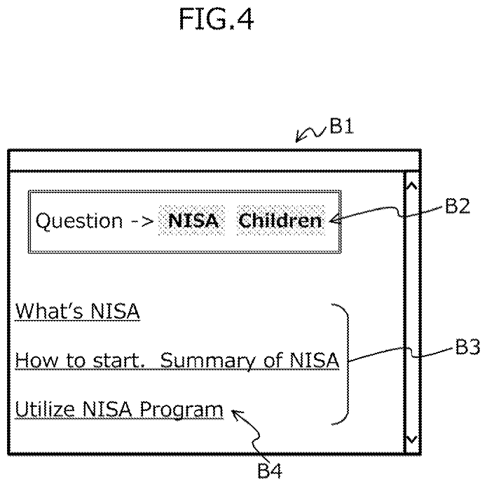

FIG. 4 is a diagram illustrating an example of a search list screen B1 displayed on a display device of the terminal 2. A search list screen B1 is a screen that displays a list of the candidates for the result for the search. For example, the search list screen B1 may be a screen of an application such as a Web browser.

As illustrated in FIG. 4, the search list screen B1 may include a search question B2 that the terminal 2 transmits to the search device 3, and multiple candidates B3 for the result of the search that the search device 3 transmits to the terminal 2 in response to the search question B2. In the example of FIG. 4, the candidates B3 for the result of the search are represented by underlined letter strings. The candidates B3 for the result of the search are, for example, letter strings, such as hyperlinks, set for transition, so that when any of the candidates B3 is selected by the operating unit 22, the display can transit to a Web page indicating the content (the result of the search) of the candidate B3 for the result of the search.

For example, it is assumed that the operator selects (e.g., clicks) a candidate for the result of the search that “Utilize NISA Program” indicated by a reference sign B4 via the operating unit 22.

In the reference sign A3 of FIG. 1, the terminal 2 selects a part (sentence) to be an answer to solve the doubt from the Web page indicating the content (search result) of the candidate B4 for the result of the search, and transmits the selected sentence (selected sentence 41b) to the FAQ generating device 4. The selected sentence 41b is an example of a sentence included in the result of the search related to the question 41a.

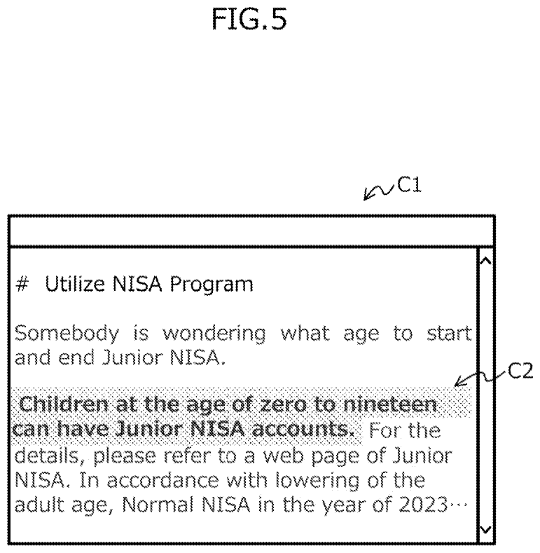

FIG. 5 is a diagram illustrating an example of a search result screen C1 displayed on the display device of the terminal 2. A search result screen C1 is a screen displaying the content (the result of a search) of the candidate B4 for the result of the search selected in the search list screen B1. Alternatively, the search result screen C1 may be a screen displaying the content that the search engine 32 evaluates to be the optimum solution in response to question 41a (by skipping outputting the search list screen B1). For example, the search result screen C1 may be a screen of an application such as a Web browser.

The operator browses the content of the search result screen C1 and selects a sentence corresponding to the answer to his/her doubt. In the examples of FIG. 1 and FIG. 5, the sentence “Children at the age of zero to nineteen can have Junior NISA accounts.” indicated by a reference sign C2 is selected by the operating unit 22.

If a suitable answer to the doubt is not included in the search result screen C1 or if the operator wishes to refer to the contents of another candidate B3 for the result of the search, the operator may returns to the search list screen B1 via the operating unit 22. Alternatively, the operator may return to the process of the reference sign A1 and send a new question 41a from the terminal 2 to the search device 3.

Further, the selected sentence 41b may be transmitted from the terminal 2 to the FAQ generating device 4 in response to an operation input for transmitting the sentence C2. As an example, when the sentence C2 is selected, the display controlling unit 23 may display thereon a confirmation screen as to whether transmission is required or not. In this case, if the operating unit 22 selects requirement of transmission, the communicating unit 21 may transmit the selected sentence 41b to the FAQ generating device 4.

When the operating unit 22 selects the sentence C2, the communicating unit 21 transmits the question 41a and the selected sentence 41b to the FAQ generating device 4. The question 41a is an example of a text inputted as a search question, and is ““NISA” “Children”” in the example of FIG. 4. The selected sentence 41b is an example of a sentence C2 selected by the operator from among the results of the search displayed on search result screen C1 as a result of searching based on the question 41a, and is “Children at the age of zero to nineteen can have Junior NISA accounts.” in the example of FIG. 5.

The question 41a may be transmitted to the FAQ generating device 4 before the operator selects the selected sentence 41b. For example, the communicating unit 21 may transmit the question 41a to the search device 3 when (or after) transmitting the question 41a to the FAQ generating device 4 (see reference sign A1 in FIG. 1).

In the reference sign A4 of FIG. 1, the FAQ generating device 4 generates, based on the question 41a of the reference sign A1 and the selected sentence 41b of the reference sign A2, a QA pair 51 which is a combination of a question sentence (question) and the answer sentence (answer), and registers the generated QA pair to the DB 5.

Returning back to the explanation of FIG. 3, the FAQ generating device 4 may illustratively include a memory unit 41, an obtaining unit 42, a question sentence generating unit 43, and a registration controlling unit 44. The obtaining unit 42, the question sentence generating unit 43, and the registration controlling unit 44 are examples of the control unit 45, and may be achieved by, for example, the hardware of the computer 10 (see FIG. 2) serving as the FAQ generating device 4.

The memory unit 41 is an example of a storing region and stores various types of data that the FAQ generating device 4 uses. The memory unit 41 may be achieved by, for example, a storing region that one or the both of the memory 10c and the storing unit 10d illustrated in FIG. 2 possess.

As illustrated in FIG. 3, the memory 41 may illustratively be capable of storing the question 41a, the selected sentence 41b, a machine learning model 41c, and a question sentence 41d.

The obtaining unit 42 obtains various types of information used in the FAQ generating device 4. For example, the obtaining unit 42 may obtain the question 41a and the selected sentence 41b from the terminal 2 serving as an example of a sender and store them into the memory 41.

The machine learning model 41c may be one trained so as to generate the question sentence 41d containing a letter string of the question 41a or being related to the letter string of the question 41a, the selected sentence 41b serving as the answer of the question sentence 41d. Note that a rule base may be used in place of the machine learning model 41c.

The machine learning model 41c is an example of the neural network model. Examples of the architecture of the neural network include an architecture used for natural-language processes such as RNN (Recurrent Neural Network) and Transformer.

The FAQ generating device 4 may obtain a machine learning model 41c trained by another computer via the obtaining unit 42 or may train the machine learning model 41c in the following manner.

Hereinafter, description will now be made in relation to an example of a machine learning process on the machine learning model 41c by the FAQ generating device 4. For example, the description assumes that the following combination of a question, an answer sentence, and a question sentence shall be used as one piece of the training data.
Question: “Baseball” “Practice” “Hard”
Answer Sentence: “If the player's movements are slower than usual, they may overwork.”
Question Sentence: “It's hard to practice, what should I do?”

As mentioned above, the inputted data is two piece of the question and the answer sentence. The FAQ generating device 4 connects the question and the answer sentence with separable delimiters (e.g., “/”, etc.) and treats them as a single text. In the following description, the inputted data is assumed to be a connected text.

When inputting the inputted data into the machine learning model 41c, the FAQ generating device 4 performs a space inserting process on the inputted data, and then converts the inputted data into a One-Hot vector sequence having dimensions corresponding to the number of words for use. In addition, the FAQ generating device 4 performs a space inserting process on the outputted data (correct answer data) likewise, and then converts the outputted data into a One-Hot vector sequence having a dimension corresponding to the number of words.

As an example, description will now be made in relation to an example of converting the text “Practice is hard” into a One-Hot vector sequence. The FAQ generating device 4 performs a space inserting process on the text “Practice is hard”, which is consequently converted into “Practice”, “Is”, and “Hard”. Then, the FAQ generating device 4 converts these three words into a three-dimensional One-Hot vector sequence ((0, 0, 1), (1, 0, 0), (0, 1, 0)) of the order of the dimension corresponding to as the number of words. In the above example, the number of words is three, but in practice, the number of words such as several thousand to several tens of thousands, which corresponds to the order of the dimension, may be used.

The FAQ generating device 4 trains the machine learning model 41c by comparing the output (predicted result) obtained by inputting the One-Hot vector sequence of the input data into the machine learning model 41c and the One-Hot vector sequence of the output data and correcting a possible error. For example, the FAQ generating device 4 may optimize the parameters by updating, in the gradient descent method, the parameters of the neural network in the direction to reduce a loss function that defines an error between the inference result of the One-Hot vector sequence of the input data by the machine learning model 41c and One-Hot vector sequence of the output data.

The question sentence generating unit 43 obtains the question sentence 41d as the inference result by inputting the question 41a and the selected sentence 41b obtained by the obtaining unit 42 into the above-described trained machine learning model 41c, and stores the obtained question sentence 41d into the memory unit 41.

For example, in the inference process, the question sentence generating unit 43 performs, likewise the above machine-learning process, connection with separable delimiters, the space inserting process, and conversion into a One-Hot vector sequence on the question 41a and the selected sentence 41b, and then inputs the One-Hot vector sequence into the machine learning model 41c.

Then, the question sentence generating unit 43 obtains a vector sequence of the question sentence 41d as an inference result from the machine learning model 41c, generates words corresponding to the respective vectors based on the obtained vector sequence, and connects the generated words to generate a question sentence 41d.

In the inference process, each vector sequence outputted from the machine learning model 41c is not a discrete value like a One-Hot vector, but a continuous value such as (0.034, 0.015, 0.951), (0.874, 0.094, 0.032), (0.140, 0.818, 0.042)). For this reason, the question sentence generating unit 43 may generate, for example, a words corresponding to the largest-valued dimension in each vector (in the above-described example, a word corresponding to each of the vectors ((0, 0, 1), (1, 0, 0), (0, 1, 0))).

In the above process, the question sentence generating unit 43 can obtain a question sentence 41b containing a letter string of the question 41a or being related to the letter string of the question 41a and also being generated such that the letter string of the selected sentence 41b comes to be the answer of the question sentence 41d. In the example of FIG. 1, on the basis of a question 41a ““NISA” “Children”” and the selected sentence 41b “Children at the age of zero to nineteen can have Junior NISA accounts”, the question sentence generating unit 43 obtains a question sentence 41d “Can children use NISA?”.

The registration controlling unit 44 controls registration of a QA pair 51, which associates the selected sentence 41b obtained by the obtaining unit 42 with the question sentence 41d that the question sentence generating unit 43 generates on the basis of the question 41a and the selected sentence 41b, into the DB 5.

For example, the registration controlling unit 44 may present a QA pair 51 to the operator (terminal 2) to confirm whether to register the QA pair 51 into the DB 5, and upon receipt of a response (instruction) indicating of the registration, register the QA pair 51 into the DB 5. This stores QA pairs 51 having preferable quality (in other words, guaranteed quality) that has been approved by the operator in the DB 5. In addition, it is possible to suppress the registration of a poor-quality QA pair 51 due to an erroneous selection of a question sentence 41d or the like.

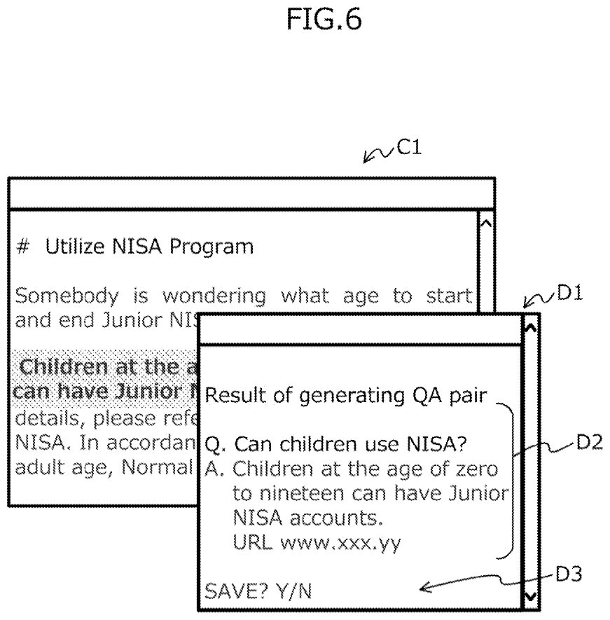

FIG. 6 is a diagram illustrating an example of a QA pair registration confirming screen D1 displayed on the display device of the terminal 2. A QA pair registration confirming screen D1 is a screen for inquiring, after the sentence C2 is selected (i.e., the selected sentence 41b is transmitted) on the search result screen C1 (see FIG. 5), the operator whether to register the QA pair 51 generated on the basis of the question 41a and the selected sentence 41b into the DB 5. For example, the QA pair registration confirming screen D1 may be a screen of an application such as a Web browser, and may be displayed in various manners, such as an overlay or pop-up on the search result screen C1.

As illustrated in FIG. 6, the QA pair registration confirming screen D1 may include a display region D2 of the information of a QA pair 51 and a display region D3 of confirmation of saving. For example, the display region D2 of the information of a QA pair 51 may display thereon, for example, Q (Question) and A (Answer). The symbol “A” (Answer) may include, for example, a link (e.g., URL: Uniform Resource Locator) to a Web page (search result screen C1) of the result of the search from which the answer is cited.

If the operator confirms the content of the QA pair registration confirming screen D1 and agrees to register the QA pair 51 into the DB 5 (for example, if the operator determines the QA pair 51 to satisfy the quality), the operator selects “Y”, for example, in the display region D3 of confirmation of saving. In response to the selection of “Y”, for example, the communicating unit 21 of the terminal 2 instructs the registration controlling unit 44 to register the QA pair 51 into the DB 5 by sending a reply indicating registration to the FAQ generating device 4.

### (D) Example of Operation

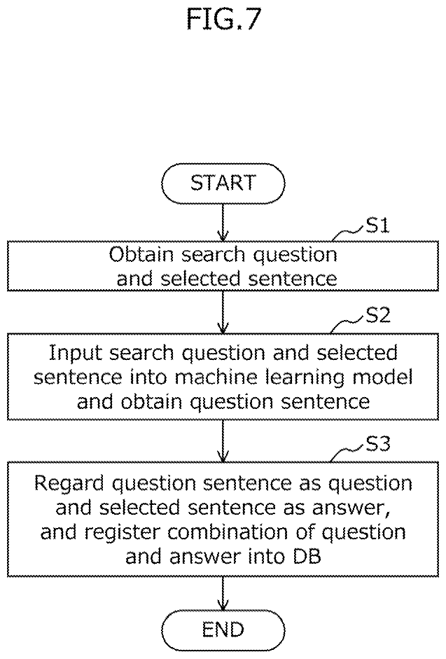

Next, description will now be made in relation to example of operation of the FAQ generating device 4 of the one embodiment. FIG. 7 is a flow diagram illustrating an example of operation of the FAQ generating device 4 of the one embodiment.

As illustrated in FIG. 7, the obtaining unit 42 of the FAQ generating device 4 obtains a question 41a and a selected sentence 41b (Step S1; see reference signs A1 and A3 in FIG. 1).

The question sentence generating unit 43 inputs the question 41a and the selected sentence 41b into the machine learning model 41c, and obtains the question sentence 41d based on the question 41a and the selected sentence 41b from the machine learning model 41c (Step S2).

The registration controlling unit 44 registers a combination of the question sentence 41d and the selected sentence 41b as a combination of a question and an answer, which means a QA pair 51, into the DB 5 (Step S3; see reference sign A4 in FIG. 1), and the process of the FAQ generating device 4 ends. The registration in Step S3 may be executed when a response indicating the execution of registration is received from the terminal 2.

### (E) Effect of the One Embodiment

As described above, the FAQ generating device 4 of the one embodiment input the question 41a and the selected sentence 41b contained in the result of the search related to the question 41a into the machine learning model 41c, and obtains a question sentence 41d based on the question 41a and the selected sentence 41b. The FAQ generating device 4 then registers a combination of the question sentence 41d and the selected sentence 41b, as a combination of a question and an answer (QA pair 51), into the DB 5. This makes it possible to enhance the quality of the generated QA pairs 51.

Additionally, since the operator can easily generate an FAQ in the process of the workflow using the search engine 32, it is possible to reduce the large number of processes and costs such as labor costs, as compared with the case where the operator collects information in order to maintain an FAQ.

Furthermore, for example, a conceivable method of generating an FAQ extracts questions and/or answers from a file, a text, or the like. However, a “doubt” that is algorithmically extracted from a file or a text does not always match a “doubt” that a man conceives. Thus, the method may generate questions and/or answers that nobody is interested in. In contrast to the above, the FAQ generating system 1 uses information on a doubt of an operator exemplified by a question 41a (operation log) input by the operator as doubt information, so that it is possible to generate questions and answers that are high in both usability and quality.

Further, for example, when a response history of mails is used as the file or the text, the response history includes a sentence that would be a noise other than questions and responses. On the other hand, in the FAQ generating system 1, since the operator designates the selected sentence 41b that is to serve as the answer, it is possible to reduce the effect of lowering of the quality (accuracy) of the FAQ caused by noises.

Further, another conceivable method generates a question sentence by using one type of information such as a search question. However, the operator is sometimes unable to specify the doubt when searching, and consequently may generate a vague question. On the other hand, the FAQ generating system 1 uses an answer sentence (a selected sentence 41b selected from the result of a search of a Web page or the like) that serves as a clue to solve the user's doubt and can generate a more specific question sentence 41d.

In addition, a still another method generates a question sentence by selecting one or more words that are to be a target of a question from a given text. However, it is essential for this method that a target word for a question exists in the text, and if the word does not exist, there is a possibility that a poor-quality question sentence is generated. On the other hand, since the FAQ generating system 1 uses the question 41a as a target word (keyword) for question, it is possible to reduce the possibility of generating a poor-quality question.

As an example, even if the text (selected sentence 41b) has no subject, the FAQ generating device 4 can infer the subject from the question 41a. For example, an assumed case has a question 41a of “What's NISA” and a selected sentence 41b of “As a benefit, tax exemption for 20-year dividends.” The FAQ generating device 4 can then generate, from question 41a, a question sentence 41d that complements the subject “NISA,” such as “What is the benefit of NISA?.”

Further, applying the FAQ generating system 1 makes it possible to mark a text DB embedding therein various pieces of information with an FAQ and associate a question and an answer with each other, so that the text DB is expected to be further utilized. For example, it is difficult for an operator or a user to search a huge amount of manuals for required information, but once an FAQ is generated, a significant part of the manuals can be quickly referred to.

### (F) Miscellaneous

The technique according to the one embodiment described above can be implemented by changing or modifying as follows.

For example, the software configurations included in each of the apparatuses of the terminal 2, the search device 3, the FAQ generating device 4 of FIG. 3 may be each merged or divided at any combination. One or the both of the search device 3 and the DB 5 may be provided to the FAQ generating device 4.

In addition, the FAQ generating device 4 illustrated in FIG. 3 may have a configuration (system) that achieves each processing function by multiple apparatuses cooperating with each other via a network. As an example, the memory unit 41 may be a DB server, the obtaining unit 42 and the registration controlling unit 44 may be a Web server or an application server, and the question sentence generating unit 43 may be an application server. In this case, the processing functions as the FAQ generating device 4 may be achieved by the DB server, the application server, and the web server cooperating with one another via a network.

As one aspect, the present disclosure can enhance the quality of a combination of a question and an answer in the generation of the combination.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a registering program that causes one or more computers to execute a process comprising:
inputting a search question and a sentence contained in a result of a search related to the search question into a machine learning model and obtaining a question sentence based on the search question and the sentence contained in the result of the search from the machine learning model; and
registering a combination of the question sentence and the sentence contained in the result of the search, serving as a combination of a question and an answer, into a storing device.

2. The non-transitory computer-readable recording medium according to claim 1, wherein the machine learning model is trained so as to generate the question sentence containing a letter string of the search question or being related to the letter string, the sentence contained in the result of the search serving as an answer of the question sentence.

3. The non-transitory computer-readable recording medium according to claim 1, wherein the registering comprises
presenting the combination of the question sentence and the sentence contained in the result of the search to a sender of the search question and the sentence contained in the result of the search; and
upon receipt of an instruction to register the combination from the sender, registering the combination of the question sentence and the sentence contained in the result of the search, serving as the combination of the question and the answer, into the storing device.

4. A computer-implemented method for registering comprising:
inputting a search question and a sentence contained in a result of a search related to the search question into a machine learning model and obtaining a question sentence based on the search question and the sentence contained in the result of the search from the machine learning model; and
registering a combination of the question sentence and the sentence contained in the result of the search, serving as a combination of a question and an answer, into a storing device.

5. The computer-implemented method according to claim 4, wherein the machine learning model is trained so as to generate the question sentence containing a letter string of the search question or being related to the letter string, the sentence contained in the result of the search serving as an answer of the question sentence.

6. The computer-implemented method according to claim 4, wherein the registering comprises:
presenting the combination of the question sentence and the sentence contained in the result of the search to a sender of the search question and the sentence contained in the result of the search; and
upon receipt of an instruction to register the combination from the sender, registering the combination of the question sentence and the sentence contained in the result of the search, serving as the combination of the question and the answer, into the storing device.

7. An information processing apparatus comprising:
a memory;
a processor coupled to the memory, the processor being configured to:
input a search question and a sentence contained in a result of a search related to the search question into a machine learning model and obtain a question sentence based on the search question and the sentence contained in the result of the search from the machine learning model; and
register a combination of the question sentence and the sentence contained in the result of the search, serving as a combination of a question and an answer, into a storing device.

8. The information processing apparatus according to claim 7, wherein the machine learning model is trained so as to generate the question sentence containing a letter string of the search question or being related to the letter string, the sentence contained in the result of the search serving as an answer of the question sentence.

9. The information processing apparatus according to claim 7, the registering comprises:
presenting the combination of the question sentence and the sentence contained in the result of the search to a sender of the search question and the sentence contained in the result of the search; and
upon receipt of an instruction to register the combination from the sender, registering the combination of the question sentence and the sentence contained in the result of the search, serving as the combination of the question and the answer, into the storing device.
